(19) United States
(12) Patent Application Publication
(10) Pub. No.: US 2020/0346829 A1
(43) Pub. Date: Nov. 5, 2020

(54) MATERIAL SUPPLY DEVICE AND SPOUT

(71) Applicant: THREEBOND CO., LTD., Hachioji-shi, Tokyo (JP)

(72) Inventors: Hirohiko TANAKA, Hachioji-shi (JP); Hajime KIBE, Hachioji-shi (JP); Shigeyuki OHNO, Hachioji-shi (JP)

(73) Assignee: THREEBOND CO., LTD., Hachioji-shi, Tokyo (JP)

(21) Appl. No.: 16/754,525

(22) PCT Filed: Aug. 13, 2018
(86) PCT No.: PCT/JP2018/030216

§ 371 Date: Apr. 8, 2020

(30) Foreign Application Priority Data
Oct. 26, 2017 (JP) 2017-207209

(51) Int. Cl. B65D 75/58; B05C 11/10

(52) U.S. Cl. CPC B65D 75/5883; B65D 2575/583; B65D 75/5866; B05C 11/10

(57) ABSTRACT

A material supply device and a spout mounted in a bag body that can efficiently output a material in an accommodation space when the material accommodated in the accommodation space of the bag body is output using a squeeze unit such as rollers, and can inhibit a decrease in the strength of the bag body which is caused by contact between the squeeze unit and the spout. A material supply device according to the present invention includes a bag assembly including a bag body that includes an accommodation space which accommodates a material, and a spout that includes a passage which delivers the material in the accommodation space to an outside, and is mountable in the bag body; and a squeeze unit that squeezes the bag body toward the spout to move the material in the accommodation space toward the spout.

### TECHNICAL FIELD

The present invention relates to a material supply device and a spout.

### BACKGROUND ART

In the related art, a viscous material with a high viscosity such as a reactive silicone, a urethane resin, or an epoxy resin as a sealant or an adhesive is used in a material supply device. For example, as described in Patent Literature 1, such a material is pressure-fed and discharged onto a seal surface of a workpiece or the like by a follower plate or a pressurizing plate in a state where the material is accommodated in an inner bag (bag body).

### CITATION LIST

### Patent Literatures

Patent Literature 1: JP 2002-255285 A

### SUMMARY OF INVENTION

In the material supply device, when a viscous material accommodated in an accommodation space of the bag body is output by squeeze members such as rollers, the squeeze members move toward an outlet of the bag body to squeeze the bag body, so that the viscous material accommodated therein moves toward the outlet of the bag body. Here, when it is intended that as much the viscous material as possible inside the bag body is output to the outside without remaining therein, the rollers move until coming into contact with a spout with the bag body interposed therebetween. When the rollers interfere with (come into contact with) the spout with the bag body interposed therebetween, the rollers cannot further advance in an advance direction. In this case, a part of the viscous material which is positioned ahead of a contact part in the accommodation space of the bag body in the advance direction of the rollers cannot be output from the bag body, and remains in the accommodation space of the bag body.

In addition, when the rollers come into contact with the spout with the bag body interposed therebetween, a stress may concentrate in a part of a front surface of the bag body, which is pinched between the spout and the rollers. In this case, the strength of the part of the bag body which is pinched between the rollers and the spout may decrease.

Accordingly, an object of the present invention is to provide a material supply device and a spout mounted in a bag body which can efficiently output a material in an accommodation space when the material accommodated in the accommodation space of the bag body is output using a squeeze unit such as rollers, and can inhibit a decrease in the strength of the bag body which is caused by contact between the squeeze unit and the spout.

A material supply device according to an aspect of the present invention includes a bag assembly and a squeeze unit. The bag assembly includes a bag body that includes an accommodation space which accommodates a material, and a spout that includes a passage which delivers the material in the accommodation space to an outside, and is mountable in the bag body. The squeeze unit includes a member which squeezes the bag body toward the spout to move the material in the accommodation space toward the spout. The spout includes a bag body contact portion that is in contact with an inner surface of the bag body, and a squeeze contact portion that is provided adjacent to the bag body contact portion and is able to come into contact with the squeeze unit with the bag body interposed between the squeeze contact portion and the squeeze unit. An outer peripheral edge of the bag body contact portion and an outer peripheral edge of the squeeze contact portion are connected to each other by a straight line or a curved line when viewed from a thickness direction of the bag body in a state where the spout is mounted in the bag body.

A spout according to another aspect of the present invention is configured to be mountable in a bag body which includes an accommodation space which accommodates a material and of which the material in the accommodation space is deliverable to an outside by a squeeze unit. The spout includes a bag body contact portion that is in contact with an inner surface of the bag body; and a squeeze contact portion that is adjacent to the bag body contact portion, is provided with a passage which delivers the material in the accommodation space to the outside, and is able to come into contact with the squeeze unit with the bag body interposed between the squeeze contact portion and the squeeze unit. An outer peripheral edge of the bag body contact portion and an outer peripheral edge of the squeeze contact portion are connected to each other by a straight line or a curved line when viewed from a thickness direction of the bag body in a state where the spout is mounted in the bag body.

### BRIEF DESCRIPTION OF DRAWINGS

FIG. 1 is a perspective view illustrating a material supply device according to an embodiment of the present invention.

FIG. 2 is a front view illustrating the material supply device according to the embodiment of the present invention.

FIG. 3 is a plan view illustrating the material supply device according to the embodiment of the present invention.

FIG. 4 is a perspective view illustrating a container.

FIG. 5 is a perspective view illustrating a bag body after a spout is removed from the container illustrated in FIG. 4.

FIG. 6 is a plan view illustrating a modification example of the bag body illustrated in FIG. 4.

FIG. 7 is a perspective view illustrating the spout according to the embodiment of the present invention.

FIG. 8 is a side view illustrating the spout according to the embodiment of the present invention.

FIG. 9 is a front view illustrating the spout according to the embodiment of the present invention.

FIG. 10 is a perspective view illustrating a nozzle.

FIG. 11 is a perspective view illustrating a state where the nozzle is attached to the spout.

FIG. 12 is a bottom view illustrating the state where the nozzle is attached to the spout.

FIG. 13 is a cross-sectional view taken along line 13-13 in FIG. 12.

FIG. 14 is an exploded perspective view illustrating the configuration of a squeeze unit.

FIG. 15 is a front view illustrating a movable squeeze member forming the squeeze unit.

FIG. 16 is a front view illustrating an attachment member forming the squeeze unit.

FIG. 17 is a front view illustrating a pinch portion forming the squeeze unit.

FIG. 18 is a flowchart describing a material supply method.

FIG. 19 is a view describing a mode for delivering a material accommodated in the bag body.

FIG. 20 is a view describing a state where rollers deliver the material and come into contact with the spout.

FIG. 21 is a view describing a mode for removing the nozzle from the spout.

FIG. 22 is a view describing a mode for inserting the nozzle into a new (another) bag assembly.

FIG. 23 is a front view illustrating a modification example of the spout.

FIG. 24 is a perspective view illustrating a modification example of the spout.

### DESCRIPTION OF EMBODIMENTS

Hereinafter, an embodiment of the present invention will be described with reference to the accompanying drawings.

Incidentally, hereinafter, in the description using the drawings, an orthogonal coordinate system and a cylindrical coordinate system are illustrated in the drawings. An x direction in the orthogonal coordinate system is a direction where a bag body 11 and a spout 20 to be described later line up, and is referred to as an axial direction for convenience. Reference sign z corresponds to a height direction of a device, and y denotes a width direction of a bag assembly which is orthogonal to the axial direction x and the height direction z. r in the cylindrical coordinate system denotes a radial direction or a diameter direction of substantially cylindrical members such as the spout 20. θ denotes a circumferential direction, an angular direction, or a rotational direction of cylindrical members such as the spout 20.

### Material Supply Device

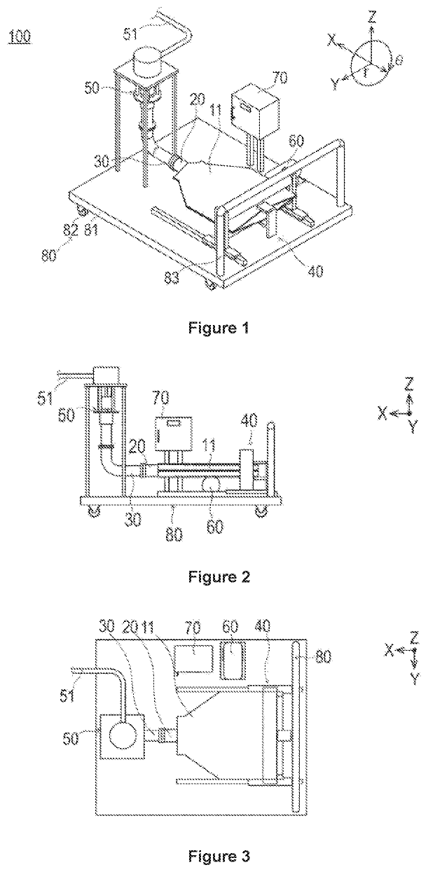

FIGS. 1 to 17 are views provided for the description of a material supply device according to an embodiment of the present invention. A material supply device 100 according to this embodiment used to supply a viscous material such as a modified silicone-based, silicone-based, urethane-based, or the like moisture curable resin as a sealant, an adhesive, or the like. The range of the viscosity of the viscous material which is suitable for the present invention is preferably a range of 20 to 1,000 Pa·s, more preferably a range of 50 to 500 Pa·s, and particularly preferably a range of 75 to 350 Pa·s.

In addition, the thixotropic ratio of the viscous material is preferably in a range of 1.0 to 5, further preferably a range of 1.5 to 5, and particularly preferably a range of 1.7 to 3. Incidentally, the thixotropic ratio is a characteristic value indicating the ease of flow of the viscous material, and is defined as a ratio obtained by dividing a viscosity when the shear rate is 1 (1/s) by a viscosity when the shear rate is 10 (1/s) using a rheometer.

When briefly described with reference to FIG. 1 and the like, the material supply device 100 includes a bag assembly 10 that accommodates a material, a nozzle 30 connected to the hag assembly 10, a squeeze unit 40 that squeezes the bag assembly 10, and a pump 50 that delivers the material in the bag assembly 10.

In addition, the material supply device 100 includes a motor 60 that supplies power, a control unit that controls the pump 50 and the like, and a movement unit 80 that enables the entire device to move. Hereinafter, a detailed description will be given.

### Bag Assembly

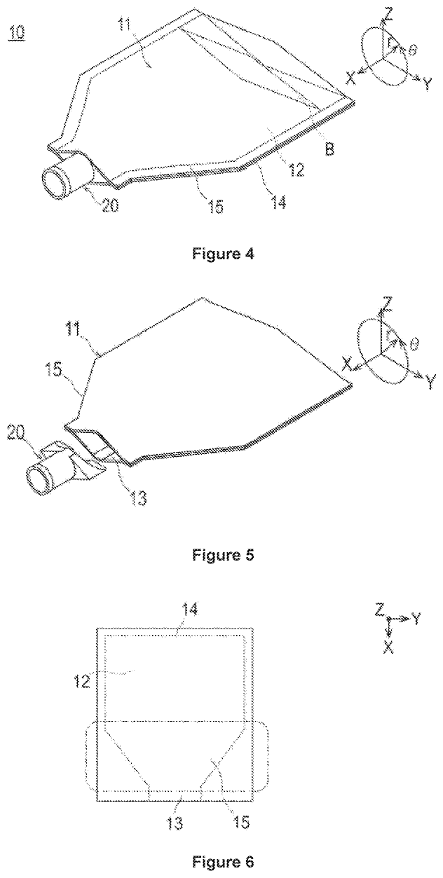

The bag assembly 10 includes the bag body 11 including an accommodation space 12 which accommodates the material as illustrated in FIGS. 4, 5, and 7, and the spout 20 that is attached to an opening portion 13 of the bag body 11 and includes a passage 23 which delivers the material in the accommodation space 12 to the outside.

As illustrated in FIGS. 4 and 5, the bag body 11 includes the accommodation space 12 that accommodates the viscous material inside the bag body 11, and the opening portion 13 for outputting the viscous material in the container. In addition, the bag body 11 includes a welded portion 14 that is formed by sealing a part other than the opening portion 13, and a reduction portion 15 which is formed in the accommodation space 12 and in which the cross-sectional area of the accommodation space 12 is reduced toward the opening portion 13.

As illustrated in FIG. 4, for example, the bag body is formed by preparing two sheets made of polyethylene or the like which correspond to side surfaces, and disposing a sheet serving as a bottom surface B between the two sheets serving as the side surfaces. However, as long as the bag body 11 can accommodate a predetermined amount of the viscous material, the bag body 11 is not limited to being formed in the above manner, and may be formed, for example, without using the sheet serving as the bottom surface B in addition to being formed in the above manner.

The bag body 11 is formed by welding a region except the opening portion 13 in the two sheets.

The welded portion 14 is a part where a predetermined number of sheets overlap each other and are joined so as to form the accommodation space 12 in the bag body 11. In FIG. 5 and the like, the welded portion 14 is formed by overlapping the two sheets and welding an outer peripheral portion except the opening portion 13.

It is preferable that the above sheets forming the bag body 11 are multilayer bodies. The multilayer body has a structure where a plurality of polyethylene, polyethylene terephthalate, nylon, or aluminum sheets or the like are combined.

As described above, the bag body 11 is formed by welding the two sheets except the opening portion 13; however, the bag body 11 is not limited to being formed in this manner. As long as the bag body 11 can accommodate the viscous material, one sheet may be folded to overlap itself, and outer peripheral portions of overlapped sheet pieces may be welded while an opening portion remains.

The accommodation space 12 is a space formed inside the bag body 11, and the viscous material before the viscous material is delivered by the squeeze unit 40 and the like is accommodated in the accommodation space 12. A silicone-based, urethane-based, or the like moisture curable viscous material as a sealant, an adhesive, or the like is accommodated in the accommodation space 12.

The opening portion 13 is a part, to which the spout 20 is attached, in an overlapped portion of the sheets forming the bag body 11. In this embodiment, the opening portion 13 is provided in a part of an outer periphery in a region where the two sheets overlap each other. However, as long as the spout 20 can be attached to an opening portion, the opening portion may be provided in a region other than the overlapped part of the sheets, for example, at the center or the like of the sheet forming the bag body 11.

As illustrated in FIGS. 4 and 5, the reduction portion 15 is a part of the bag body 11, in which the cross-sectional area of the accommodation space 12 is reduced in the axial direction x (a diagonally left downward direction in FIGS. 4 and 5) where the squeeze unit 40 is moved toward the spout 20. In other words, the reduction portion 15 is a part that approaches (is tapered) the opening portion 13 as the positions of both end portions of the accommodation space 12 when the bag body 11 is viewed from a thickness direction (the height direction z) approach the opening portion 13.

As such, in FIG. 5, the outer form of the bag body 11 in the reduction portion 15 is a tapered shape toward the opening portion 13 similar to the shape of the accommodation space 12 of the bag body 11. However, as long as the bag body 11 can be formed such that the cross-sectional area of the accommodation space 12 is reduced toward the opening portion 13, the outer shape of the bag body 11 is not limited to that illustrated in FIG. 5. The outer shape of the bag body 11 may be formed by, for example, a rectangular sheet as illustrated in FIG. 6 in addition to being that illustrated in FIG. 5.

In addition, as long as the bag body 11 can be squeezed by the squeeze unit 40, the outer shape of the bag body 11 may be a shape other than that illustrated in FIG. 4. The outer shape of the reduction portion 15 is illustrated with the straight line in FIG. 4; however, the outer shape may be curved as long as viscous material in the container can hardly remain.

### Spout

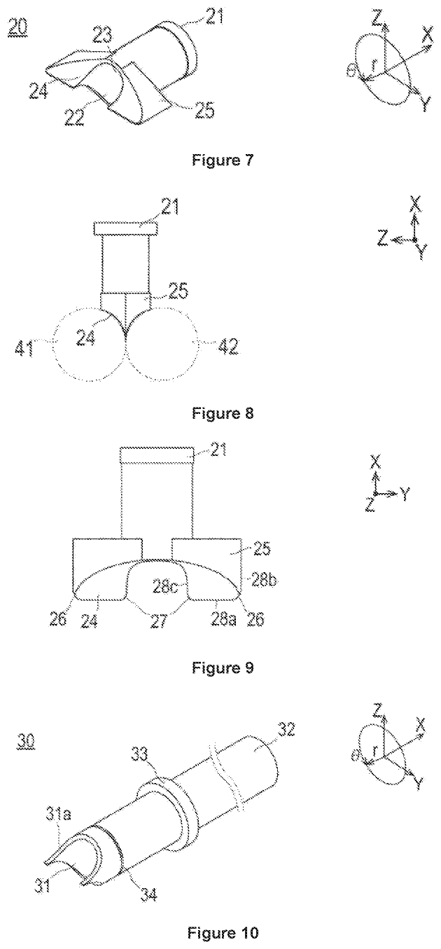

FIGS. 7 to 9 are a perspective view, a side view, and a bottom view illustrating the spout 20. As illustrated in FIGS. 7 to 9, the spout 20 includes an outlet port 21 for the viscous material which is disposed outside in the axial direction x when the spout 20 is attached to the opening portion 13 of the bag body 11, and an inlet port 22 for the viscous material which is positioned inside when the spout 20 is attached to the opening portion 13. The spout 20 includes the passage 23 which connects the outlet port 21 and the inlet port 22 and through which the viscous material flows, a contact portion 24 that comes into contact with squeeze members 41 and 42 forming the squeeze unit 40, and a joint portion 25 joined to the bag body 11.

In this specification, the inlet port 22 is equivalent to an opening portion, the contact portion 24 is equivalent to a squeeze contact portion, and the joint portion 25 is equivalent to a bag body contact portion.

The outlet port 21 is formed in a cylindrical shape including an opening. The inlet port 22 communicates with the outlet port 21. The passage 23 has a hollow shape which connects the inlet port 22 and the outlet port 21, and the viscous material from the accommodation space 12 flows through that portion and is delivered from the outlet port 21 to the outside.

The joint portion 25 is a part positioned between two substantially circular shapes indicated by the two-dot lines in FIG. 8, and corresponds to a part that is in contact with inner surfaces of the sheets forming the bag body 11. As illustrated in FIG. 7, the joint portion 25 is formed such that the width of the joint portion 25 in the height direction z increases from the side toward the center. The spout 20 is mounted in the bag body 11 by being joined to the bag body 11 at the joint portion 25.

The contact portion 24 is a part that comes into contact with the squeeze member 41 or the squeeze member 42 which form the squeeze unit 40, when the bag body 11 is squeezed using the squeeze unit 40. Incidentally, the term “contact” referred to here implies that the squeeze members 41 and 42 and the contact portion 24 come into contact with each other with the sheets forming the bag body 11 interposed therebetween. The contact portion 24 has a surface with the same shape or substantially the same shape as that of a part of the squeeze members 41 and 42 so that the contact portion 24 can come into contact with the squeeze members 41 and 42 as without gap as possible, and has a curved surface in this embodiment.

The contact portion 24 is provided adjacent to the joint portion 25. As illustrated in a corner 26 in FIG. 9, an outer peripheral edge (surface 28a in FIG. 9) of the contact portion 24 and an outer peripheral edge (surface 28b in FIG. 9) of the joint portion 25 are connected to each other by a curved line when viewed (viewed in a perspective manner) from the thickness direction (height direction z) of the bag body 11 in a state where the spout 20 is mounted in the bag body 11.

Namely, the corner 26 is equivalent to a part where the outer peripheral edge of the contact portion 24 and the outer peripheral edge of the joint portion 25 intersect each other. The corner 26 is formed in a shape obtained by cutting an acute angular corner into a curved surface when a side surface of the bag body 11 illustrated in FIG. 9 is viewed from the height direction z. In this embodiment, in the surface 28a and the surface 28b illustrated in FIG. 9, the dimension in the height direction z is very much smaller than the dimensions in the axial direction x and the width direction y. However, as long as the bag body 11 can be joined to the joint portion 25 and the contact portion 24 can come into contact with the squeeze members 41 and 42, specific dimensions of the surfaces 28a and 28b are not limited to the above dimensions.

As illustrated in FIG. 9, an edge of the inlet port 22 is provided on the contact portion 24. The edge of the inlet port 22 is formed on the contact portion 24. With such a configuration, in the delivering of the viscous material in the accommodation space 12, when the squeeze members 41 and 42 come into contact with the contact portion 24, the viscous material from the accommodation space 12 can flow through the passage 23 of the spout 20 with almost no remainder.

In addition, an outer peripheral edge (surface 28c in FIG. 9) of the inlet port 22 through which the passage 23 is inserted in the contact portion 24 and a tip portion (surface 28a in FIG. 9) of the contact portion 24 in a flow-through direction of the material are connected to each other by a curved line (refer to a corner 27 in FIG. 9). Similar to the corner 26, the corner 27 is formed in a shape obtained by cutting a corner, in which the surface 28a and the surface 23c intersect each other, into a curved surface.

In addition, the contact portion 24 is a part that is not welded to the sheets forming the bag body 11. The ratio of the front surface area between the joint portion 25 and the contact portion 24 in the spout 20 can be, for example, 2.8:7.2.

### Nozzle

FIGS. 10 to 13 are views provided for the description of the nozzle 30.

The nozzle 30 is inserted into the spout 20 when the viscous material in the bag body 11 is delivered to the outside. As illustrated in FIGS. 10 to 13, the nozzle 30 includes a spout inserted portion 31, a pump connected portion 32, and a flange 33 for determining the insertion position of the spout inserted portion 31 with respect to the spout 20. In addition, the nozzle includes an attachment groove 34 to which a seal member which seals a gap between the nozzle 30 and the spout 20 is attached.

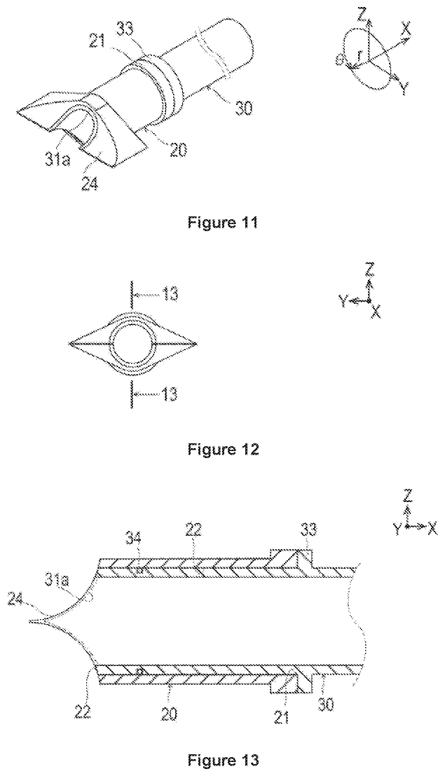

The nozzle 30 is formed in a substantially cylindrical shape including an opening. The spout inserted portion 31 corresponds to a portion that is provided at a tip of the nozzle 30 and is inserted into the spout 20. The spout inserted portion 31 has substantially the same outer diameter as an inner diameter of the passage 23 of the spout 20. As illustrated in FIGS. 10 and 11, the spout inserted portion 31 includes a tip portion 31a positioned on a most tip side in the axial direction x.

As illustrated in FIG. 13, when the flange 33 is brought into contact with a flange of the outlet port 21 of the spout 20, the tip portion 31a is formed to be substantially flush with a surface of the contact portion 24 of the spout 20. Incidentally, FIG. 11 is a view illustrating a state where the spout 20 is attached to the nozzle 30 illustrated in FIG. 10. The tip portion 31a is in contact with the squeeze members 41 and 42 with the sheets of the bag body 11 interposed therebetween in a state where the tip portion 31a is substantially flush with the contact portion 24.

Incidentally, the term “contact” referred to here also has the same implication as that in the description of the contact portion 24 of the spout 20. In addition, in FIG. 13, the contact portion 24 and the tip portion 31a overlap each other, and in order to distinguishably illustrate the contact portion 24 and the tip portion 31a, intentionally, the line of the tip portion 31a is illustrated with the two-dot line while being slightly shifted from the line of the contact portion 24.

The flange 33 is provided at a position where as described above, the tip portion 31a is substantially flush with the contact portion 24 when the nozzle 30 is inserted into the spout 20. The pump connected portion 32 is equivalent to a part that is positioned on a base portion side of the nozzle 30 and is connected to the pump 50. Since the shape of the pump connected portion 32 is the same as the known shape in the related art, a detailed description thereof will be omitted. As illustrated in FIGS. 10 and 13 and the like, the attachment groove 34 has a shape of a groove provided in an outer surface of the substantially cylindrical shape. The seal member such as an O-ring is attached to the attachment groove 34.

### Squeeze Unit

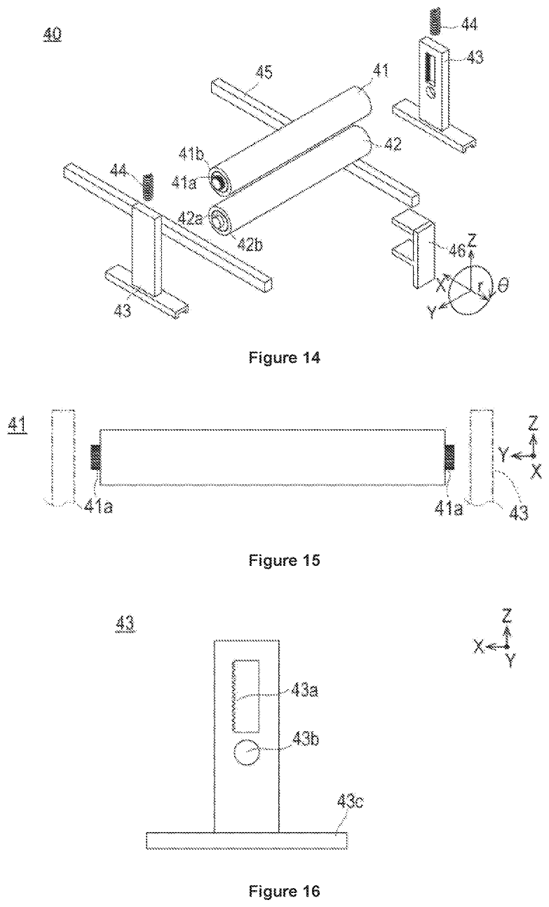

FIGS. 14 to 17 are views provided for the description of the squeeze unit 40.

The squeeze unit 40 is used when the viscous material accommodated in the bag body 11 is delivered to the outside. As illustrated in FIGS. 14 to 17, the squeeze unit 40 includes a pair of the squeeze members 41 and 12 that are in contact with an exterior surface of the bag body 11 and squeeze the bag body 11 to push out the material in the accommodation space 12 toward the passage 23 of the spout 20, and a pair of attachment member 43 for attaching the squeeze members 41 and 42. In addition, the squeeze unit 40 includes a resilient member 44 that applies a resilient force for pressing the squeeze member 41 toward the squeeze member 42 to squeeze the bag body 11, a pair of linear guides 45 that move the attachment members 43 with respect to the bag body 11, and a pinch portion 46 that pinches the bag body 11.

The squeeze member 41 is configured to be able to approach and separate from the squeeze member 42. The squeeze member 41 is configured to be able to move with respect to the squeeze member 42 such that a gap between the squeeze member 41 and the squeeze member 42 can be adjusted along an attachment portion 43a formed in the attachment member 43 illustrated in FIG. 16.

As illustrated in FIG. 15, the squeeze member 41 includes an attachment portion 41a attached to the attachment members 43. In addition, the squeeze member 41 includes a rotary portion 41b that is formed as a member separate from the attachment portion 41a and is disposed outside the attachment portion 41a to be able to rotate the squeeze member 41 when the attachment members 43 are moved with respect to the bag body 11.

The attachment portion 41a is a shaft portion positioned in a central portion of the squeeze member 41. The attachment portion 41a is provided with a tooth shape as that of a pinion which meshes with a shape as that of a rack provided in the attachment member 43. Since the attachment portion 41a is configured as described above, the gap between the squeeze member 41 and the squeeze member 42 can be adjusted.

Since the rotary portion 41b is formed separately from the attachment portion 41a and for example, a bearing or the like is disposed between the attachment portion 41a and the rotary portion 41b, the rotary portion 41b is configured to be able rotate independently from the operation of the attachment portion 41a. Since the squeeze member 41 is configured as described above, when the squeeze member 41 is moved using the attachment members 43, the rotary portion 41b can squeeze the bag body 11 while rotating.

As illustrated in FIG. 14, the squeeze member 42 includes an attachment portion 42a and a rotary portion 42b. Unlike the squeeze member 41, the squeeze member 42 is attached to the attachment members 43 in a fixed manner. For this reason, a tooth shape as that of the pinion as provided in the squeeze member 41 is not provided in a shaft portion. However, the squeeze member 42 is not limited to the above configuration, and similar to the squeeze member 41, a tooth shape as that of the rack may be provided. Since the rotary portion 42b is the same as the rotary portion 41b of the squeeze member 41, a description thereof will be omitted.

In addition, in FIG. 14 and the like, the squeeze unit 40 is configured to include the squeeze members 41 and 42; however, the squeeze unit 40 is not limited to the above configuration, and as long as the bag body 11 can be squeezed, a configuration where the bag body 11 is placed on a fiat plate and is pressed and squeezed by one squeeze member from above may be adopted.

In addition, in this embodiment, the squeeze members 41 and 42 are a pair of rollers that are in contact with the exterior surface of the bag body 11, and perform a squeeze operation while rotating as described above. However, the squeeze members 41 and 42 are not limited to the above manner, and may be configured to perform a squeeze operation by sliding like a scraper without rotating contact surfaces in addition to the above manner. In that case, as long as the shape of the squeeze member coincides with the surface of the contact portion 24 of the spout 20, the shape of the squeeze member may be not only a cylindrical shape but also, for example, a polygonal shape in cross-section.

The attachment members 43 are attached to end portions of the squeeze members 41 and 12, and enable the squeeze members 41 and 42 to move on the linear guides 45. As illustrated in FIGS. 14 and 16, the attachment member 43 include the attachment portion 43a for attaching the squeeze member 41 and enabling the gap between the squeeze member 41 and the squeeze member 42 to be adjusted. In addition, the attachment member 43 includes an attachment portion 43b for attaching the squeeze member 42, and a rail attachment portion 43c that movably attaches the attachment member 43 to the linear guide 45.

The attachment portion 43a is provided in a side surface in the attachment member 43, and is provided inside when the attachment member 43 is disposed on the linear guide 45. The attachment portion 43a is formed by forming grooves shaped as a rack on which the squeeze member 41 moves; however, as long as the gap between the squeeze member 41 and the squeeze member 42 can be adjusted, the attachment portion 43a is not limited to the above configuration.

In addition, the resilient member 44 is attached to the attachment portion 43a. The resilient member 44 prevents or inhibits a pressing force against the bag body 11 from being weakened by a reaction force when the squeeze member 41 presses the bag body 11 together with the squeeze member 42. One end of the resilient member 44 is attached to the attachment portion 43a of the attachment member 43 and the other end thereof is attached to the squeeze member 41, so that the resilient member 44 applies a resilient force (elastic force) to press the squeeze member 41 toward the squeeze member 42.

In this embodiment, as illustrated in FIG. 14, the resilient member 44 is formed of a spring which is an elastic member. However, as long as the reduction in pressing force by the squeeze members 41 and 42 can be prevented or inhibited, a member other than a spring may be used.

The attachment portion 43b is formed for the attachment of the squeeze member 42 thereto. The attachment portion 43b is configured to have a recess shape for attaching the shaft portion of the squeeze member 42. However, as long as the squeeze member 42 can be attached thereto, the shape of the attachment portion 43b is not limited to the recess shape.

The rail attachment portion 43c is configured to allow the attachment member 43 to move on the linear guide 45, and is attached to the linear guide 45.

As illustrated in FIG. 14, the linear guide 45 has a rail shape for moving the attachment member 43 to which the squeeze members 41 and 42 are attached. However, as long as the rail attachment portion 43c and the linear guide 45 can move the attachment member 43, the configurations thereof are not limited to the above configuration.

The pinch portion 46 prevents a squeeze operation from not being able to be performed due to the bag body 11 being deformed as the squeeze members 41 and 42 move when the bag body 11 is squeezed by the squeeze members 41 and 42. The pinch portion 46 pinches and holds an end portion of the bag body 11 which is substantially opposite to a position where the spout 20 is attached thereto.

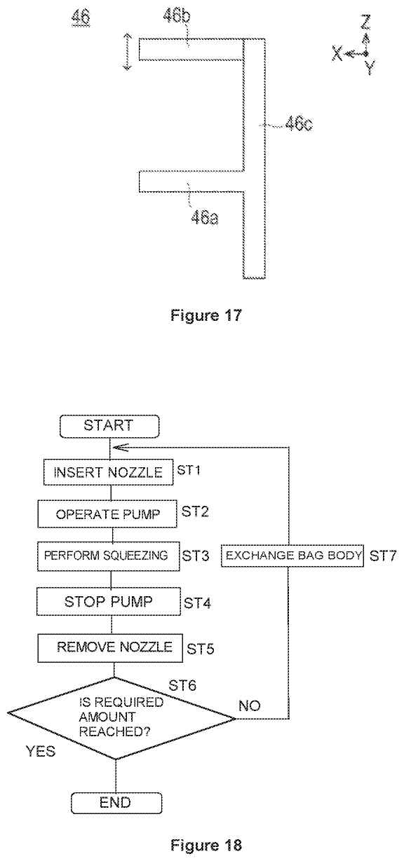

As illustrated in FIG. 17, in order to pinch the bag body 11, the pinch portion 46 includes a fixed portion 46a in contact with a front surface of the bag body 11, and a movable portion 46b that is in contact with a surface of the bag body 11 which is opposite to the surface in contact with the fixed portion 46a and is configured to be able to approach and separate from the fixed portion 46a. In addition, the pinch portion 46 includes an attachment portion 46c to which the fixed portion 46a is attached and the movable portion 46b is movably attached.

The fixed portion 46a is substantially horizontally attached to the attachment portion 46c. However, as long as the fixed portion 46a can pinch the bag body 11 together with the movable portion 46b, the mode of attachment is not limited to be horizontal. The movable portion 46b is attached to the attachment portion 46c so as to be movable by a drive source (not illustrated). The attachment portion 46c is installed upright on the linear guide 45. The attachment portion 46c is installed in a fixed manner. However, for example, in order to pinch end portions of containers with various sizes, the attachment portion 46c may be movably configured similar to the attachment member 43.

### Other Components

As illustrated in FIGS. 1 to 3, the pump 50 pressure-feeds the viscous material, which is delivered from the nozzle 30 inserted into the spout 20, through a pipe 51 and the like. For example, a plunger pump, a gear pump, a screw pump, and the like can be applied as the pump 50; however, the pump 50 is not limited to the above pumps.

The motor 60 is configured to supply power to operate the squeeze members 41 and 42 forming the squeeze unit 40 and the attachment members 43, and since the motor 60 is the same as the known motor in the related art, a detailed description thereof will be omitted. The control unit 70 includes a CPU, a memory, an input and output interface, and the like for operating the pump 50 or the motor 60.

As illustrated in FIG. 1 and the like, the movement unit 80 includes a mounted portion 81 for installing the squeeze unit 40, the motor 60, and the pump 50, rollers 82 that are configured to enable the mounted portion 81 to move, and a handle portion 83 that is used when the material supply device 100 is moved by a human or the like.

The mounted portion 81 is formed of a plate member or the like made of metal. The rollers 82 are rollers that are installed at four corners of a lower portion of the mounted portion 81, and enable the material supply device 100 to move. The handle portion 83 is formed, for example, by attaching a metallic pipe-shaped member to an upper portion of the mounted portion 81, and serves as a handle portion that is used when a human or the like moves the material supply device 100.

### Material Supply Method

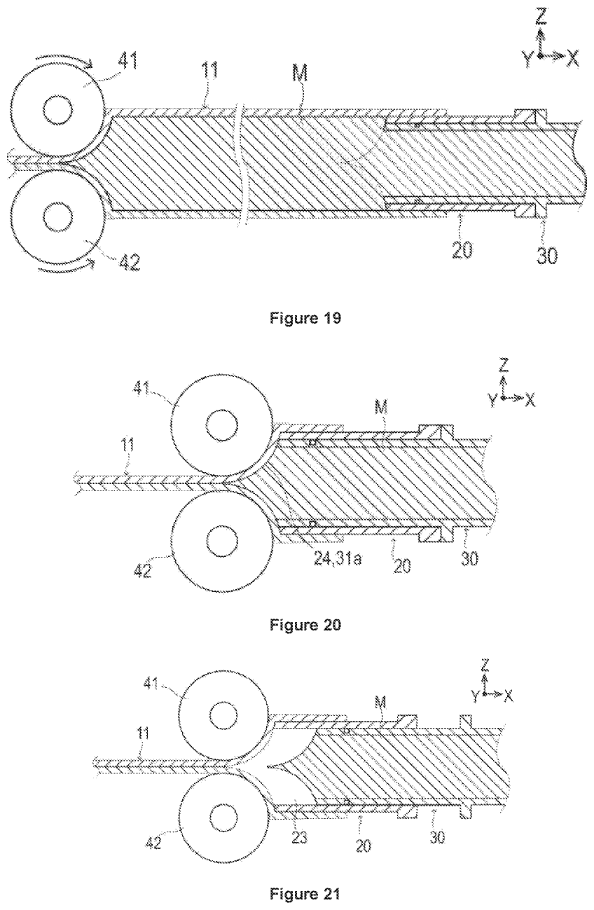

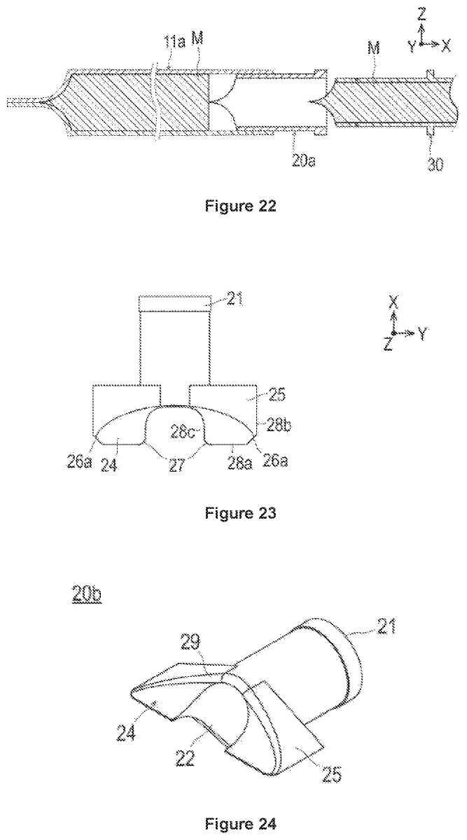

Subsequently, a material supply method using the material supply device according to this embodiment will be described. FIG. 18 is a flowchart describing a viscous material supply method according to the embodiment of the present invention, and FIGS. 19 and 20 are views describing a mode for delivering the viscous material accommodated in the bag body. FIG. 21 is a view describing a mode for removing the nozzle from the spout, and FIG. 22 is a view describing a mode for inserting the nozzle into a new (another) container.

When briefly described with reference to FIG. 18, the viscous material supply method includes inserting the nozzle 30 into the spout 20 (ST1), operating the pump 50 (ST2), a squeeze operation by the squeeze unit 40 (ST3), stopping the pump 50 (ST4), and removing the nozzle 30 (ST5).

Firstly, as illustrated in FIGS. 11 to 13, the nozzle 30 is inserted and attached to the passage 23 of the spout 20. Subsequently, as illustrated in FIG. 1, the end portion opposite to the spout 20 is pinched and set by the pinch portion 46 (ST1). Then, the pump 50 is operated (ST2).

Subsequently, as illustrated in FIG. 19, while maintaining a state where the bag body 11 is pressed and pinched using the squeeze members 41 and 42, the attachment members 43 are moved on the linear guides 45 toward the spout 20 to perform a squeeze operation. Therefore, a viscous material M which is present other than around the spout 20 in the accommodation space 12 of the bag body 11 moves toward the spout 20.

Then, the viscous material M present in the accommodation space 12 is delivered to the outside from the nozzle 30 inserted into the spout 20. As illustrated in FIG. 20, when the squeeze members 41 and 42 come into contact with the contact portion 24 of the spout 20 and the tip portion 31a of the spout inserted portion 31 of the nozzle 30 with the sheets of the bag body 11 interposed therebetween, the squeeze operation ends (ST3).

Here, when the squeeze members 41 and 42 come into contact with the contact portion 21 of the spout 20 with the sheets of the bag body 11 interposed therebetween, the bag body 11 is pinched between either of the squeeze members 41 and 42 and the spout 20. The outer peripheral edge of the contact portion 24 of the spout 20 and the outer peripheral edge of the joint portion 25 are connected to each other by a curved surface as that of the corner 26 when viewed from the height direction z (thickness direction of the bag body 11). For this reason, even when the bag body 11 is pinched between either of the squeeze members 41 and 42 and the spout 20, a stress concentration can hardly occur in a part of the bag body 11 which comes into contact with the corner 26 or the like of the spout 20. Therefore, it is possible to inhibit a decrease in the strength of the bag body 11.

The description returns to the description of the method. The viscous material M delivered from the nozzle 30 is pressure-fed by the pump 50.

Subsequently, the pump 50 is stopped (ST4). When the pump 50 is stopped, as illustrated in FIG. 21, the nozzle 30 is removed from the spout 20 (ST5). Therefore, the viscous material M which may remain in the passage 23 of the spout 20 is removed from the spout 20 in a state where the viscous material M is input into the nozzle 30.

In a case where the amount of the viscous material M to be delivered is equivalent to that of a plurality of the bag bodies 11, when the delivery of the viscous material M does not reach a required amount (ST6: NO), the bag body 11 is exchanged with a new bag body (ST7). Then, until the delivery of the viscous material M reaches the required amount (ST6: YES), the operations from the insertion of the nozzle 30 (ST1) to the removal of the nozzle 30 (ST5) with respect to spouts 20a of new bag bodies 11a filled with the viscous material M which is illustrated in FIG. 22 are repeated.

As described above, the material supply device 100 in this embodiment includes the bag assembly 10 and the squeeze unit 40. The bag assembly 10 includes the bag body 11 that includes the accommodation space 12 which accommodates the viscous material M, and the spout 20 that includes the passage 23 which delivers the viscous material M in the accommodation space 12 to the outside, and can be mounted in the bag body 11. The squeeze unit 40 includes the squeeze members 41 and 42 that squeeze the bag body 11 toward the spout 20 to move the viscous material M in the accommodation space 12 toward the spout 20. The spout 20 includes the joint portion 25 that is in contact with an inner surface of the bag body 11, and the contact portion 24 that is provided adjacent to the joint portion 25 and can come into contact with the squeeze unit 40 with the bag body 11 interposed between the contact portion 24 and the squeeze unit 40. The outer peripheral edge of the contact portion 24 and the outer peripheral edge of the joint portion 25 are connected to each other by a curved surface as that of the corner 26 when viewed from the thickness direction of the bag body 11 in a state where the spout 20 is mounted in the bag body 11.

For this reason, a gap between the squeeze unit 40 and the contact portion 24 in a state where the bag body 11 interposed therebetween when the contact portion 24 comes into contact with the squeeze unit 40 can be made relatively small. Therefore, it is possible to efficiently output the viscous material M in the accommodation space 12 of the bag body 11. In addition, owing to the curved shape of the corner 26, it is possible to inhibit a stress from concentrating in the part of the bag body 11 which comes into contact with the corner 26 or the like when the squeeze unit 40 comes into contact with the spout 20 with the bag body 11 interposed therebetween. Therefore, it is possible to inhibit a decrease in the strength of the bag body 11.

In addition, the outer peripheral edge of the inlet port 22 through which the passage 23 is inserted in the contact portion 24 and the surface 28a corresponding to the tip portion of the contact portion 21 in the flow-through direction of the viscous material M are connected to each other by a curved line as that of the corner 27 when viewed from the thickness direction of the bag body 11. For this reason, it is possible to inhibit a decrease in the strength of the bag body 11 which may come into contact with the corner 27 when the squeeze unit 40 comes into contact with the contact portion 24 of the spout 20 with the bag body 11 interposed therebetween.

The present invention is not limited to the above embodiment, and various changes can be made without departing from the scope of the claims.

FIGS. 23 and 24 are a front view and a perspective view illustrating modification examples of the spout. The embodiment where the outer peripheral edge of the contact portion 24 and the outer peripheral edge of the joint portion 25 are curved surfaces as that of the corner 26 in FIG. 9 when viewed from the thickness direction of the bag body 11 has been described above. However, as long as a stress concentration in the bag body 11 can be inhibited when the squeeze members 41 and 42 pinch the bag body 11 together with the spout 20, a specific shape of the corner 26 is not limited to a curve line when viewed from the thickness direction of the bag body 11. In addition to the above shape, as the shape of a corner 26a illustrated in FIG. 23, the shape when viewed from the thickness direction of the bag body 11 may be a straight line (so-called chamfer). In addition, similar to the corner 26a, the corner 27 may also be a straight line when viewed from the thickness direction of the bag body 11.

In addition, the embodiment where the corners 26 and 27 of the contact portion 24 are formed in a curved line when viewed from the thickness direction of the bag body 11 has been described above. However, the present invention is not limited to the above embodiment. As illustrated in FIG. 24, a spout 20b may be configured co include a boundary portion 29 that is disposed between the contact portion 24 and the joint portion 25 and has an outer shape which is curved from the contact portion toward the joint portion 25. Therefore, it is possible to inhibit a stress concentration in the vicinity of the boundary portion 29 of the bag body 11 when the squeeze members 41 and 42 pinch the bag body 11 together with the spout 20, and it is possible inhibit a decrease in the strength of that part of the bag body 11.

Incidentally, present application is based on Japanese Patent Application No. 2017-207209, filed on Oct. 26, 2017, the entire content of which is herein by reference.

### REFERENCE SIGNS LIST

10 BAG ASSEMBLY
11, 11a BAG BODY
12 ACCOMMODATION SPACE
15 REDUCTION PORTION
100 VISCOUS MATERIAL SUPPLY DEVICE
20, 20a, 20b SPOUT
22 INLET PORT (OPENING PORTION)
23 PASSAGE
24 (SQUEEZE) CONTACT PORTION
25 JOINT PORTION (BAG BODY CONTACT PORTION)
26, 26a CORNER (EQUIVALENT TO PART WHERE OUTER PERIPHERAL EDGE OF JOINT PORTION AND OUTER PERIPHERAL EDGE OF CONTACT PORTION INTERSECT EACH OTHER)
27 CORNER (EQUIVALENT TO PART WHERE OUTER PERIPHERAL EDGE OF INLET PORT THROUGH WHICH PASSAGE IS INSERTED IN CONTACT PORTION AND TIP PORTION OF CONTACT PORTION IN FLOW-THROUGH DIRECTION OF MATERIAL INTERSECT EACH OTHER)
28a SURFACE (OUTER PERIPHERAL EDGE OF CONTACT PORTION AND TIP PORTION OF CONTACT PORTION IN FLOW-THROUGH DIRECTION OF MATERIAL)
28b SURFACE (OUTER PERIPHERAL EDGE OF JOINT PORTION)
28c SURFACE (OUTER PERIPHERAL EDGE OF INLET PORT THROUGH WHICH PASSAGE IS INSERTED IN CONTACT PORTION)
29 BOUNDARY PORTION
40 SQUEEZE UNIT
M VISCOUS MATERIAL

1-4. (canceled)

5. A material supply device comprising:
a bag assembly including a bag body that includes an accommodation space which accommodates a material, and a spout that includes a passage which delivers the material in the accommodation space to an outside, and is mountable in the bag body; and
a squeeze unit that squeezes the bag body toward the spout to move the material in the accommodation space toward the spout,
wherein the spout includes
a bag body contact portion that is in contact with an inner surface of the bag body, and
a squeeze contact portion that is provided adjacent to the bag body contact portion and is able to come into contact with the squeeze unit with the bag body interposed between the squeeze contact portion and the squeeze unit, and
an outer peripheral edge of the bag body contact portion and an outer peripheral edge of the squeeze contact portion are connected to each other by a straight line or a curved line when viewed from a thickness direction of the bag body in a state where the spout is mounted in the bag body.

6. The material supply device according to claim 5,
wherein an outer peripheral edge of an opening portion through which the passage is inserted in the squeeze contact portion and a tip portion of the squeeze contact portion in a flow-through direction of the material are connected to each other by a straight line or a curved line when viewed from the thickness direction.

7. The material supply device according to claim 5,
wherein the squeeze contact portion and the bag body contact portion are connected to each other by a flat surface or a curved surface.

8. A spout that is mountable in a bag body which includes an accommodation space which accommodates a material and of which the material in the accommodation space is deliverable to an outside by a squeeze unit, the spout comprising:
a bag body contact portion that is in contact with an inner surface of the bag body; and
a squeeze contact portion that is adjacent to the bag body contact portion, is provided with a passage which delivers the material in the accommodation space to the outside, and is able to come into contact with the squeeze unit with the bag body interposed between the squeeze contact portion and the squeeze unit,
wherein an outer peripheral edge of the bag body contact portion and an outer peripheral edge of the squeeze contact portion are connected to each other by a straight line or a curved line when viewed from a thickness direction of the bag body in a state where the spout is mounted in the bag body.

9. The material supply device according to claim 6,
wherein the squeeze contact portion and the bag body contact portion are connected to each other by a flat surface or a curved surface.
